(19) United States
(12) Patent Application Publication
(10) Pub. No.: US 2006/0076071 A1
(43) Pub. Date: Apr. 13, 2006

(54) Open-channel plastic extrusion apparatus and method

(76) Inventors: Wassim R. Ali-Ahmad, Newport Coast, CA (US); Charles C. Hart, Summerville, SC (US)

Correspondence Address: APPLIED MEDICAL RESOUCES CORPORATION, 22872 Avenida Empresa, Rancho Santa Margarita, CA, 92688, US

(21) Appl. No.: 10/942,360

(22) Filed: Sep. 16, 2004

(51) Int. Cl. F16L 9/14; B29C 47/20

(52) U.S. Cl. 138/152; 138/157; 138/169; 264/209.1; 264/313

(57) ABSTRACT

The invention is directed to open-channel extrusions of plastic materials. In one aspect, an open-channel tubing is formed by extruding a first plastic material forming an elongate tube having the open channel; and extruding a second plastic material filling the open channel such that the second plastic material forms a weak bond with the first plastic material, and the weak bond is then selectively broken or dissolved to yield the open channel in the first plastic material. The first and second plastic materials are different from one another and each comprises at least one of polyester, polyethylene, nylon, polyurethane, HDPE, plastic elastomers (TPE) and Kraton. The first and second plastic materials are preferably extruded at about the same time. In another aspect, at least one of the first and second plastic materials may be doped with an additive to form the weak bond. The process of the invention may further comprise the step of mechanically stripping or removing the second plastic material from the first plastic material, chemically dissolving the second plastic material using a chemical solvent, or separating the second plastic material in a thermal melting process. Mechanically stripping the second plastic material may further comprise pressuring or evacuating the extruded elongate tube. To chemically dissolve the second plastic material, the first plastic material may include an aramid plastic, the second plastic material may include a styrene plastic, and the chemical solvent may be acetone or MEK. High and low-temperature plastics may be used to separate in the thermal melting process.

### BACKGROUND OF THE INVENTION

1. Field of the Invention

This invention generally relates to the extrusion of plastic materials and, in particular, to the extrusion of plastic materials in a form that results in a tube or luminal cross-section having an axial open wall portion or axial slit.

2. Discussion of Related Art

The continuous extrusion of plastic materials is known in the art of plastic processing. Generally, thermoplastic profile extrusions are made by heating a thermoplastic resin in a barrel of an extruder and forcing it through a die that shapes it into a continuous two-dimension profile. More specifically, a plastic material, usually in the form of resin pellets, is placed in a hopper to be fed into a heated compressing augur of the barrel and subsequently through the die or head that results in a preferred cross-section or profile. The preferred size of the extruded profile is determined by the amount of tension or “drawn-down” applied during the cooling phase as the extruded material exits the die or head. Extrusions can be made from a single thermoplastic, from two or more compatible thermoplastics, or with a continuous embedded reinforcement of metal or other material.

Typically, a solid profile of a given shape is easily extruded. Certain parameters are well established for maintaining the desired shape as the materials are drawn and cooled. These parameters are generally considered when forming the extrusion die or head. Extrusion is also the most appropriate process for forming lengths of tubing. Tubing formed by the extrusion process may have one lumen or it may have multiple lumens. The extrusion of some shapes, however, has somewhat defied the extrusion process. For example, a tube having an axial portion removed or a “C” shaped tube is very difficult to extrude. The desired shape and size of the “C” shaped tube is uncontrollable during the drawn-down and cooling phases. In addition, the storage of such a profile is problematic. If the “C” shaped tubing is placed on a spool, it will collapse and deform to a point where it is unusable. There are many “open-channel” shapes that are useful but are presently not available in an extruded process. Accordingly, there is a need in the art for an extrusion of an open-channel or “C” shaped tube that will not deform or collapse during draw-down or cooling phases.

### SUMMARY OF THE INVENTION

The invention is directed to open-channel extrusions of plastic materials. In one aspect, an open-channel tubing is formed by extruding a first plastic material forming an elongate tube having the open channel; and extruding a second plastic material filling the open channel such that the second plastic material forms a weak bond with the first plastic material, and the weak bond is then selectively broken or dissolved to yield the open channel in the first plastic material. The first and second plastic materials are different from one another and each comprises at least one of polyester, polyethylene, nylon, polyurethane, HDPE, plastic elastomers (TPE) and Kraton. The first and second plastic materials are preferably extruded at about the same time in another aspect, at least one of the first and second plastic materials may be doped with an additive to form the weak bond between the first and second plastic materials. The process of the invention may further comprise the step of mechanically stripping or removing the second plastic material from the first plastic material, chemically dissolving the second plastic material using a chemical solvent, or separating the second plastic material in a thermal melting process. The step of mechanically stripping or removing the second plastic material from the first plastic material may further comprise the step of pressuring or evacuating the extruded elongate tube. To chemically dissolve the second plastic material, the first plastic material may include an aramid plastic, the second plastic material may include a styrene plastic, and the chemical solvent may be acetone or MEK. To separate or dissolve the second plastic material in a thermal melting process, the first plastic material may be at least one of a high-temperature nylon, polyolefin, polyester and polyurethane and the second plastic material may be a low-temperature polyethylene plastic.

The process may further comprise the step of extruding a third plastic material with the first and second plastic materials, the third plastic material being different from the first and second plastic materials. The elongate tube has a lumen having a first shape and an outer wall having a second shape. The first and second shapes may be one of round, oval, rectangular, square, triangular or any geometrical shape.

In another aspect, the invention is directed to an open-channel tubing comprising a first elongate member comprising a first plastic material having an open channel, a first axial wall margin, and a second axial wall margin; and a second elongate member comprising a second plastic material, the second plastic material extruded to fill the open channel of the first elongate member, the second elongate member having a first edge opposing the first axial wall margin and a second edge opposing the second axial wall margin, wherein the second elongate member forms a weak bond with the first elongate member along the edges of the second elongate member and the axial wall margins of the first elongate member, and the weak bond is selectively broken or dissolved to yield the open channel in the first elongate member. The first and second plastic materials are different from one another and each comprises at least one of polyester, polyethylene, nylon, polyurethane, HDPE, plastic elastomers (TPE) and Kraton. In another aspect, the second plastic material may be doped with an additive to form the weak bond. The second elongate member or weak bond may then be separated from the first elongate member using a light or energy source such as an ultra-violet light The open-channel tubing of the invention may also be formed by mechanically stripping or removing the second elongate member from the first elongate member, chemically dissolving the second elongate member using a chemical solvent, or separating the second elongate member in a thermal melting process. To chemically dissolve the second elongate member, the first elongate member may include an aramid plastic, the second elongate member may include a styrene plastic, and the chemical solvent may be acetone or MEK. To separate or dissolve the second elongate member in a thermal melting process, the first elongate member may be at least one of a high-temperature nylon, polyolefin, polyester and polyurethane and the second elongate member may be a low-temperature polyethylene plastic.

The open-channel tubing may further comprise a third plastic material being different from the first and second plastic materials. The first elongate member has a lumen having a first shape and an outer wall having a second shape. The first and second shapes may be one of round, oval, rectangular, square, triangular or any geometrical shape.

In another aspect, an open-channel extrusion is disclosed comprising an elongate tube having a lumen extending along a longitudinal axis and a slit forming a first axial wall margin and a second axial wall margin opposing the first axial wall margin; and a co-extrusion formed between the first axial wall margin and the second axial wall margin, wherein the elongate tube is formed of a first plastic material and the co-extrusion is formed of a second plastic material different from the first plastic material that does not flow together with the first plastic material to form a permanent bond, and the co-extrusion is selectively removed between the first and second axial wall margins.

These and other features of the invention will become more apparent with a discussion of the various embodiments in reference to the associated drawings.

### DESCRIPTION OF THE DRAWINGS

The accompanying drawings, which are included in and constitute a part of this specification, illustrate the embodiments of the invention and, together with the description, explain the features and principles of the invention. In the drawings:

FIG. 1 illustrates an extrusion set-up of one material in accordance with the prior art;

FIG. 2 illustrates a solid extrusion profile;

FIG. 3 illustrates a tubular extrusion profile;

FIG. 4 illustrates a multi-lumen tubular extrusion profile;

FIG. 5 illustrates a desired open-channel “C” shaped extrusion profile;

FIG. 6 illustrates an open-channel “C” shaped extrusion profile of the prior art;

FIG. 7 illustrates other extrusion profiles that may be achieved through the process of the invention;

FIG. 8 illustrates a “cross-head” extrusion set-up for extruding two materials in accordance with the process of the invention;

FIG. 9 illustrates a “cross-head” extrusion set-up for extruding three materials in accordance with the process of the invention;

FIG. 10 illustrates a perspective view of an open-channel “C” shaped profile in accordance with the extrusion process of the invention;

FIG. 11 illustrates the preparation of the open-channel “C” shaped profile in accordance with the extrusion process of the invention;

FIG. 12 illustrates an open-channel “C” shaped profile for use in accordance with the extrusion process of the invention;

FIG. 13 illustrates an open-channel extrusion having an axial slit in the wall in accordance with another embodiment of the invention;

FIG. 14 illustrates an open-channel multi-lumen extrusion having an axial slit in one lumen in accordance with another embodiment of the invention; and

FIG. 15 illustrates an open-channel extrusion having a square shape in accordance with another embodiment of the invention.

### DESCRIPTION OF THE INVENTION

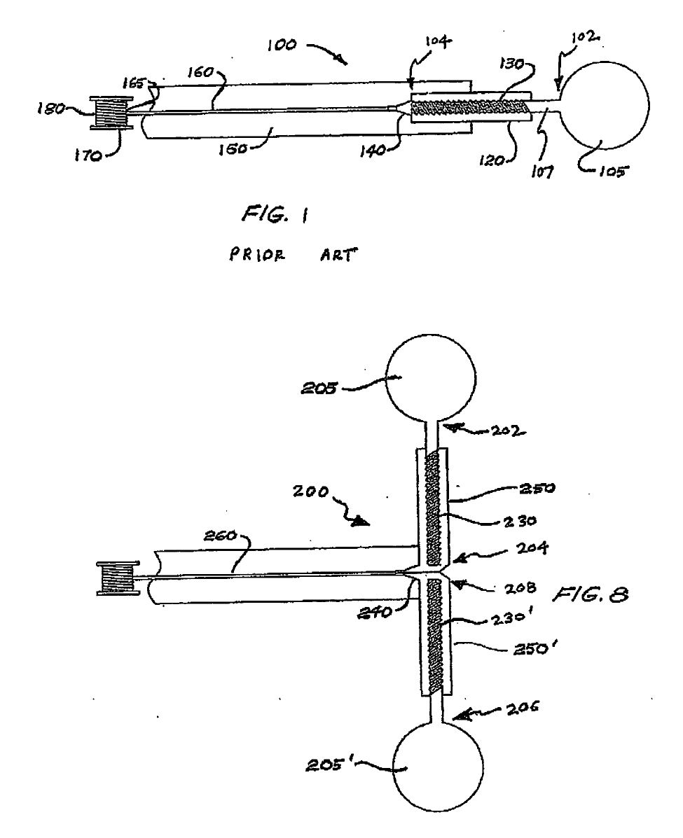

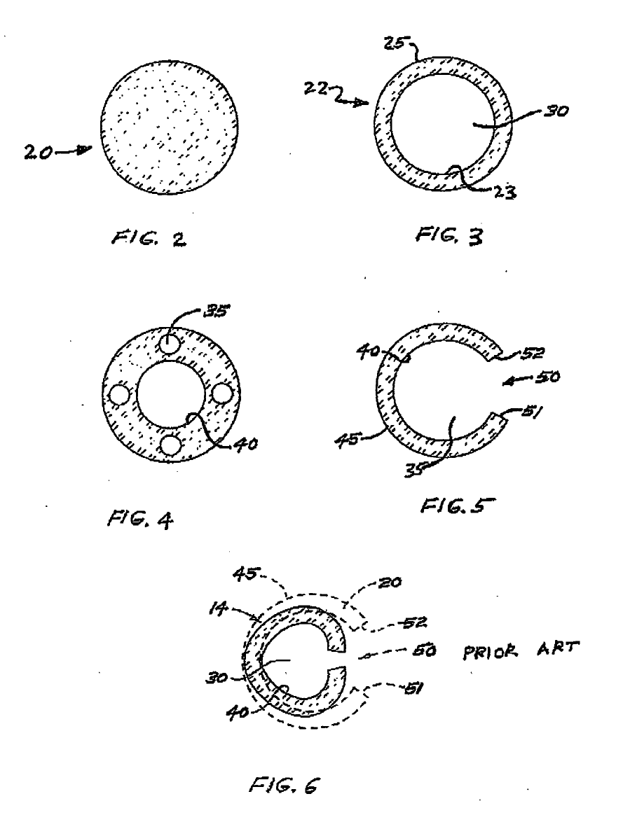

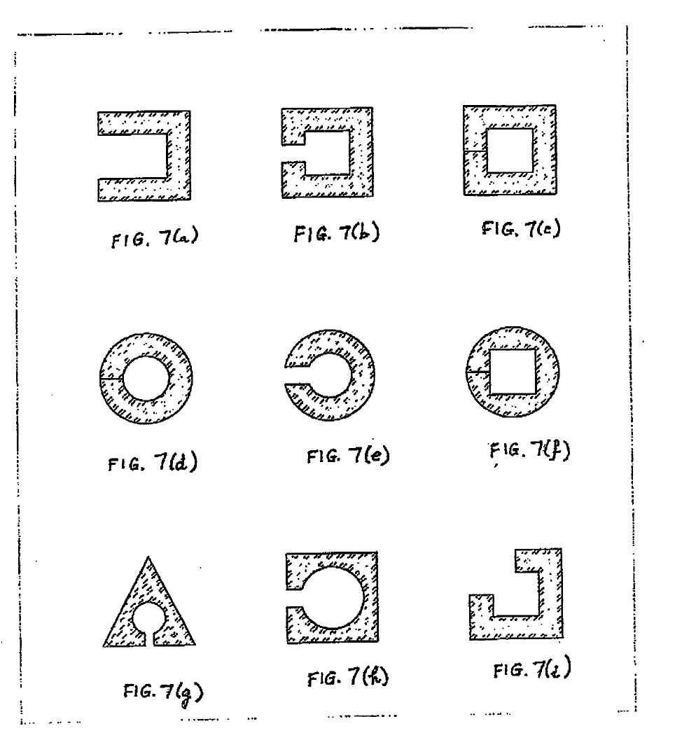

Referring to FIG. 1, there is shown a schematic drawing of a common extruder 100 including a hopper or supply chute 105 and a barrel 120 extending axially between an upstream end 102 and a downstream end 104, and a large augur 130 in the barrel 120. The extruder 100 operates to melt, or plasticate, a solid material, or a molten material having a high viscosity, and to deliver, or pump, the plasticated material to a sprue, die or form 140. A reservoir of solid material is held in the hopper or supply chute 105 which communicates with an inner chamber 107 of the barrel 120 adjacent the upstream end 102 and feeds the solid material into a channel defined by a helical flight on the augur 130. Rotation of the augur 130 within the barrel 120 will advance the material along the channel in a downstream direction until the material is delivered, in melted form, at a discharge point at the downstream end of the barrel.

More specifically, the material is a raw, palletized thermoplastic material that is supplied to the hopper or supply chute 105 and subsequently into the augur 130 where it is pressurized and heated. From the augur 130, the thermoplastic is forced under great pressure into the sprue, die or form 140. The extruded material 160 is then connected to a tensioning force 165 where it is drawn-down to the preferred size as it cools. It is subsequently cut to length or wound upon a spool 170.

Referring to FIG. 2, there is shown a solid extrusion 20 of a thermoplastic material having a solid cross-section or profile. The round extruded profile is accomplished using the extrusion process as described above and the desired thermoplastic materials and extrusion parameters. The profile is generally extruded through a heated form or die that is sized and configured to deliver the desired shape. The extruded material is generally several times greater in diameter than that of the finished product. The exact diameter is achieved by tensioning the material as it exits the heated die and is cooled. This process is referred to as the “drawn-down” phase.

Referring to FIG. 3, there is shown a hollow extrusion or tube 22 that is achieved by extruding a thermoplastic material through a heated extrusion die having a center forming portion that is connected to a gas pressure supply. As the extruded tube 22 exits the heated die, it is “drawn-down” and inflated to a preferred pressure to yield a uniform lumen 30, an inner diameter 23 and outer diameter 25.

There are occasions when a desired cross-section or profile is not completely closed as in the case of a tube having a sealed lumen. An example of such a profile is illustrated in FIG. 5 where an open-channel tube 50 is seen having generally a “C” shape. This open-channel tube 50 typically has a lumen 35, an inner diameter 40, an outer diameter 45, and two opposing ends 51, 52. While this open-channel tube 50 is relatively simple to extrude, it is difficult to control and maintain within narrow parameters. The material has a strong tendency to deform during the “draw-down” and cooling phases as further illustrated in FIG. 6. Also, it can be seen that there is no sealed lumen to inflate so that the material comprising the wall of the extrusion can be supported. As a result, the profile usually deforms and distorts to an unacceptable final shape as illustrated in FIG. 6. FIGS. 7(a)-7(i) illustrate other shapes and profiles having openings or opposing surfaces that defy standard tube extrusion.

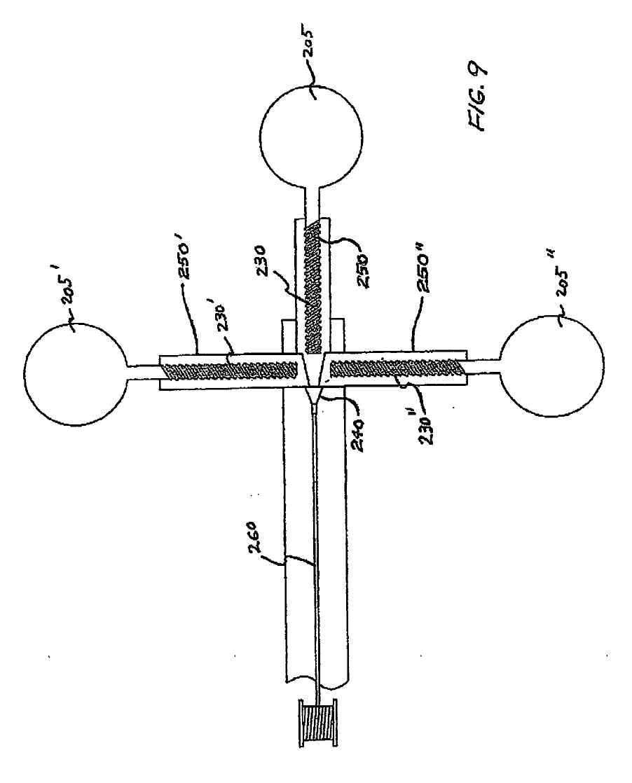

Referring to FIG. 8, there is shown a schematic drawing of a co-extruder 200 in accordance with the process of the invention including a first hopper or supply chute 205 and a barrel 250 extending axially between a first end 202 and a second end 204, and an augur 230 in the barrel 250, a second hopper or supply chute 205′ and a barrel 250′ extending axially between a third end 206 and a fourth end 208, and an augur 230′ in the barrel 250′. The co-extruder 200 operates to melt, or plasticate, a solid material, or a molten material having a high viscosity, and to deliver, or pump, the plasticated material to a sprue, die or form 240. With this set up of the invention using a plurality of raw material hoppers or supply chutes 205, 205′, a plurality of augurs 230, 230′ and a single sprue, die or form 240, several compatible materials may be processed at the same time. This process is referred to as co-extrusion of at least two materials. Generally, the two materials are selected for compatibility so that they flow together at adjoining regions 330, 325 as illustrated in FIG. 10. This process is selected often when multi-color tubing is required or where a preferred modulus is required along a specific axial region of the wall.

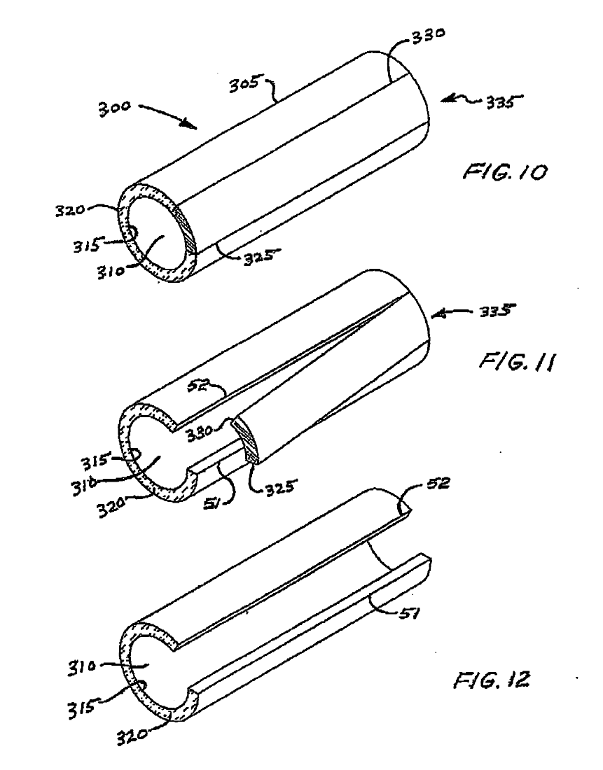

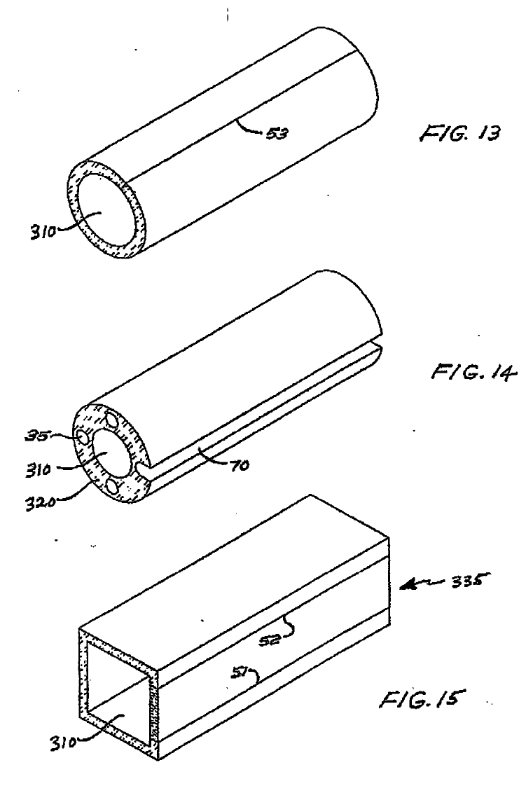

With reference to FIGS. 10-15, an extruded plastic or thermoplastic tube 300 is shown having a generally round cross-sectional profile. The tube or extrusion 300 has an outer diameter 305, a lumen 310, an inner diameter 315, a first axial wall margin 325, a second axial wall margin 330, a first extruded material 320 and a second extruded material 335. In one aspect of the invention, the first and second extruded materials 320, 335 are selected for non-compatibility so that the materials 320, 335 do not flow together to form a permanent bond or union at the converging axial wall margins 325, 330. The resulting extrusion 300 may be inflated within the lumen 310 so that the lumen 310 is maintained during the “drawn-down” and cooling phases and also as the extruded material is stored or wound upon a spool or other storage form.

The selection of materials for the open-channel extrusion 300 of the present invention may include materials that differ in species, oil content, wax content or the like. For example, the first extruded material 320 may comprise a plastic such as polyester and the second extruded material 335 may comprise polyethylene. These two extruded materials will temporarily bond but do not permanently adhere together. It is appreciated that there are many other materials that have similar characteristics. For instance, the first extruded material 320 may be selected to fit the overall requirements of the extruded profile, and the second extruded material 335 may generally be selected to assist in the processing of the first extruded material 320 and to yield an appropriate second region where the axial wall margins are separable to greater or lesser degree. The first and second extruded materials 320, 335 may include combinations of, for example, nylon, polyurethane, HDPE, thermoplastic elastomers (TPE), Kraton, and the like. In addition, various additives may be placed into one of the materials that make the adhesion or bonding of the first and second materials 320, 335 more or less aggressive.

The second material 335 may be selectively separated or stripped away from the first extruded material 320 in a final step for use. The stripping process may include mechanical stripping, pulling or expanding. For instance, an extruded tube such as tube 300 may comprise two dissimilar plastics 320, 335 that may be pressurized from within to separate the two dissimilar plastics 320, 335. Alternatively, the extruded tube 300 may be evacuated so that the dissimilar plastics 320, 335 are separated. The stripping process may also include chemical or solvent stripping. For instance, a first plastic that is not affected by a particular solvent may be co-extruded with a second plastic that is affected by that solvent. The co-extrusion is then passed through the chemical or solvent so that the affected second plastic is dissolved, weakened or disconnected from the first plastic. It is appreciated that plastics may be chosen for their sensitivity to particular solvents. For example, an aramid plastic such as nylon may be chosen as the first plastic and a styrene chosen for the second plastic. When a co-extrusion of these two plastics is passed through a solvent such as acetone or MEK, the styrene plastic will dissolve leaving the nylon extrusion in tact.

Furthermore, it should be noted that most plastics have different melting temperatures or softening temperatures. The invention contemplates the use of these differences to separate or strip the two or more components of a co-extrusion. For instance, a high-temperature nylon, polyolefin, polyester, polyurethane or the like may be co-extruded with a low-temperature polyethylene or other low-temperature plastics, The final co-extrusion may subsequently passed through a heating device that melts the low temperature plastic while leaving the higher temperature material in tact. It is further contemplated that a combination of processes may be useful to separate a dissimilar co-extrusion. For instance, a high-temperature/low-temperature co-extrusion may be pressurized from within and additionally passed through a heat source to separate the two components of the co-extrusion. Moreover, a chemically-sensitive/chemically-resistant co-extrusion may be pressurized from within and subsequently passed through a solvent to separate the components of the co-extrusion.

In another aspect of the invention, a co-extrusion according to the invention may also comprise a first material that is doped or modified to provide resistance to various energy sources, such as ultraviolet light, and a second material that is doped or modified to provide sensitivity to the energy source. When the co-extrusion is exposed to the energy source, the first and second materials react to separate from one another. Other aspects of the invention include, among other features: at least a first material being modified or doped and at least a second material not being modified or doped; at least a first material being modified with an additive and at least a second material not being modified with an additive; and at least a first material being modified or filled with a metallic material and at least a second material not being modified or filled with a metallic material.

It will be understood that many other modifications can be made to the various disclosed embodiments without departing from the spirit and scope of the invention. For these reasons, the above description should not be construed as limiting the invention, but should be interpreted as merely exemplary of preferred embodiments.

1. A method for making an open-channel tubing, comprising:
extruding a first plastic material forming an elongate tube having an open channel; and
extruding a second plastic material filling the open channel,
wherein the second plastic material forms a weak bond with the first plastic material, and the weak bond is selectively broken or dissolved to yield the open channel in the first plastic material.

2. The method of claim 1, wherein the first plastic material comprises at least one of polyester, polyethylene, nylon, polyurethane, HDPE, thermoplastic elastomers (TPE) and Kraton.

3. The method of claim 2, wherein the second plastic material is different from the first plastic material and comprises at least one of polyester, polyethylene, nylon, polyurethane, HDPE, plastic elastomers (TPE) and Kraton.

4. The method of claim 1, wherein the extruding steps of the first and second plastic materials occur at about the same time.

5. The method of claim 1, wherein at least one of the first and second plastic materials is doped with an additive to form the weak bond between the first and second plastic materials.

6. The method of claim 1, further comprising the step of mechanically stripping or removing the second plastic material from the first plastic material.

7. The method of claim 6, wherein the step of mechanically stripping or removing the second plastic material from the first plastic material further comprises the stop of pressuring or evacuating the extruded elongate tube.

8. The method of claim 1, further comprising the step of chemically dissolving the second plastic material using a chemical solvent.

9. The method of claim 8, wherein the first plastic material includes an aramid plastic and the second plastic material includes a styrene plastic.

10. The method of claim 8, wherein the chemical solvent is acetone or MEK.

11. The method of claim 1, further comprising the step of separating or dissolving the second plastic material in a thermal melting process.

12. The method of claim 11, wherein the first plastic material is at least one of a high-temperature nylon, polyolefin, polyester and polyurethane and the second plastic material is a low-temperature polyethylene plastic.

13. The method of claim 1, further comprising the step of extruding a third plastic material with the first and second plastic materials.

14. The method of claim 13, wherein the third plastic material is different from the first and second plastic materials and comprises at least one of polyester, polyethylene, nylon, polyurethane, HDPE, thermoplastic elastomers (TPE) and Kraton.

15. The method of claim 1, wherein the elongate tube has a lumen having a first shape and an outer body having a second shape.

16. The method of claim 15, wherein the first shape is one of round, oval, rectangular, square, triangular or any geometrical shape.

17. The method of claim 15, wherein the second shape is one of round, oval, rectangular, square, triangular or any geometrical shape.

18. An open-channel tubing, comprising:
a first elongate member comprising a first plastic material and having an open channel, a first axial wall margin, and a second axial wall margin; and
a second elongate member comprising a second plastic material, the second elongate member extruded to fill the open channel of the first elongate member, the second elongate member having a first edge opposing the first axial wall margin and a second edge opposing the second axial wall margin,
wherein the second elongate member forms a weak bond with the first elongate member along the edges of the second elongate member and the axial wall margins of the first elongate member, and the weak bond is selectively broken or dissolved to yield the open channel in the first elongate member.

19. The open-channel tubing of claim 18, wherein the first plastic material comprises at least one of polyester, polyethylene, nylon, polyurethane, HDPE, thermoplastic elastomers (TPE) and Kraton.

20. The open-channel tubing of claim 19, wherein the second plastic material is different from the first plastic material and comprises at least one of polyester, polyethylene, nylon, polyurethane, HDPE, thermoplastic elastomers (TPE) and Kraton.

21. The open-channel tubing of claim 18, wherein the second plastic material is doped with an additive to form the weak bond.

22. The open-channel tubing of claim 18, wherein the second elongate member is mechanically stripped or removed from the first elongate member.

23. The open-channel tubing of claim 21, wherein the first and second elongate members are separated from one another using a light or energy source.

24. The open-channel tubing of claim 23, wherein the source is an ultra-violet light.

25. The open-channel tubing of claim 18, wherein the second elongate member is chemically dissolved using a chemical solvent.

26. The open-channel tubing of claim 25, wherein the first plastic material includes an aramid plastic and the second plastic material includes a styrene plastic.

27. The open-channel tubing of claim 25, wherein the chemical solvent is acetone or MEK.

28. The open-channel tubing of claim 18, wherein the second elongate member is separated or dissolved in a thermal melting process.

29. The open-channel tubing of claim 28, wherein the first plastic material is at least one of a high-temperature nylon, polyolefin, polyester and polyurethane and the second plastic material is a low-temperature polyethylene plastic.

30. The open-channel tubing of claim 18, wherein the first elongate member further comprises a third plastic material different from the first and second plastic materials, the third plastic material comprising at least one of polyester, polyethylene, nylon, polyurethane, HDPE, thermoplastic elastomers (TPE) and Kraton.

31. The open-channel tubing of claim 18, wherein the first elongate member has a lumen having a first shape and an outer body having a second shape.

32. The open-channel tubing of claim 31, wherein the first shape is one of round, oval, rectangular, square, triangular or any geometrical shape.

33. The open-channel tubing of claim 31, wherein the second shape is one of round, oval, rectangular, square, triangular or any geometrical shape.

34. An open-channel extrusion, comprising:
an elongate tube having a lumen extending along a longitudinal axis and a slit forming a first axial wall margin and a second axial wall margin opposing the first axial wall margin; and
a co-extrusion formed between the first axial wall margin and the second axial wall margin,
wherein the elongate tube is formed of a first plastic material and the co-extrusion is formed of a second plastic material different from the first plastic material that does not flow together with the first plastic material to form a permanent bond, and the co-extrusion is selectively removed between the first and second axial wall margins.

35. The open-channel extrusion of claim 34, wherein the first plastic material comprises at least one of polyester, polyethylene, nylon, polyurethane, HDPE, thermoplastic elastomers (TPE) and Kraton.

36. The open-channel extrusion of claim 34, wherein the co-extrusion comprises at least one of polyester, polyethylene, nylon, polyurethane, HDPE, thermoplastic elastomers (TPE) and Kraton.

37. The open-channel extrusion of claim 34, wherein the co-extrusion provides the elongate tube with a sealed lumen to inflate the tube to a desired diameter.

38. The open-channel extrusion of claim 34 wherein the lumen has a first shape and the elongate tube has an outer wall having a second shape.

39. The open-channel extrusion of claim 38, wherein the first shape is one of round, oval, rectangular, square, triangular or any geometrical shape.

40. The open-channel extrusion of claim 38 wherein the second shape is one of round, oval, rectangular, square, triangular or any geometrical shape.
